(19) United States
(12) Patent Application Publication
(10) Pub. No.: US 2008/0142279 A1
(43) Pub. Date: Jun. 19, 2008

(54) METHOD AND SYSTEM FOR DETECTING UPDATES TO DATA ACQUIRED FROM PAPER FORMS USING A DIGITAL PEN

(75) Inventor: Rodney L. Sheets, Salt Lake City, UT (US)

Correspondence Address: STOEL RIVES LLP - SLC, 201 SOUTH MAIN STREET, ONE UTAH CENTER, SALT LAKE CITY, UT, 84111, US

(73) Assignee: VELOSUM, INC., Sandy, UT (US)

(21) Appl. No.: 11/954,891

(22) Filed: Dec. 12, 2007

Related U.S. Application Data
(60) Provisional application No. 60/869,866, filed on Dec. 13, 2006.

(51) Int. Cl. G06F 3/033; G06F 3/041

(52) U.S. Cl. 178/18.01; 345/179

(57) ABSTRACT

Systems and methods are provided for updating digital pen strokes written on a paper form using a digital pen. A user may write on a paper form using a digital pen that both marks the form and electronically records the marks in relation to various form fields. Thus, user selections made using the paper form and the digital pen may be automatically determined and an electronic image of the paper form may be generated that includes the user's marks. Paper forms may be identified using a series of unique dot patterns that may be repeated on a page or book level. A particular paper form is identified by its unique dot pattern and assigned a duration. This duration assignment is reconciled against a future digital paper form record that is processed to determine if the future record corresponds to a new form or an update to an existing form.

### RELATED APPLICATION

This application claims the benefit under 35 U.S.C. § 119(e) of U.S. Provisional Application No. 60/869,866, filed Dec. 13, 2006, which is hereby incorporated by reference herein in its entirety.

### TECHNICAL FIELD

This disclosure relates to electronically filling out a paper form using a digital pen. More specifically, this disclosure relates to detecting an update to data collected using a digital pen on a paper form.

### BRIEF DESCRIPTION OF THE DRAWINGS

Non-limiting and non-exhaustive embodiments of the disclosure are described, including various embodiments of the disclosure with reference to the figures, in which:

FIG. 1 is a block diagram of an example system for processing data received from a digital pen according to one embodiment;

FIG. 2 is a block diagram of a data structure for a stroke collection file according to one embodiment;

FIG. 3 is a flowchart of a method for processing form updates according to one embodiment; and

FIG. 4 graphically illustrates an example parking ticket (Parking Notice Violation to the Driver and Registered Owner) with fields that respectively include options that may be processed according to certain embodiments disclosed herein.

### DETAILED DESCRIPTION OF PREFERRED EMBODIMENTS

This disclosure is related to electronically filling out a paper form using a digital pen. A user may write on a paper form using a digital pen that both marks the form and electronically records the marks in relation to various form fields. Thus, user selections made using the paper form and the digital pen may be automatically determined and an electronic image of the paper form may be generated that includes the user's marks. Digital pens usable with the disclosure herein include, for example, a digital pen available from Anoto AB of Stockholm, Sweden (also referred to herein as an “Anoto-type” pen), a digital pen available from Hitachi Maxell Ltd. of Tokyo, Japan, or a digital pen available from Logitech Inc. of Freemont, Calif., USA.

In one embodiment, a user may write characters such as numbers, letters or words in a particular field on a form. The digital pen stores data corresponding to pen strokes in a stroke collection file as the user writes on the form. Data collected using the digital pen and paper form is transmitted (e.g., using Bluetooth) from the digital pen to a cellular phone for submission to, for example, a web based server for processing. After submitting the data collected using the digital pen, a user may decide to update the original paper form by again marking the paper form using the digital pen. Using the user's cellular phone, the user may then submit the updates to the original digital form to the web based server.

A process is described below for updating and tracking existing digital paper form data using form lifecycle management. Paper forms may be identified using a series of unique dot patterns that may be repeated on a page or book level. A particular paper form is identified by its unique dot pattern and assigned a duration. This duration assignment is reconciled against a future digital paper form record that is processed to determine if the future record corresponds to a new form or an update to an existing form.

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

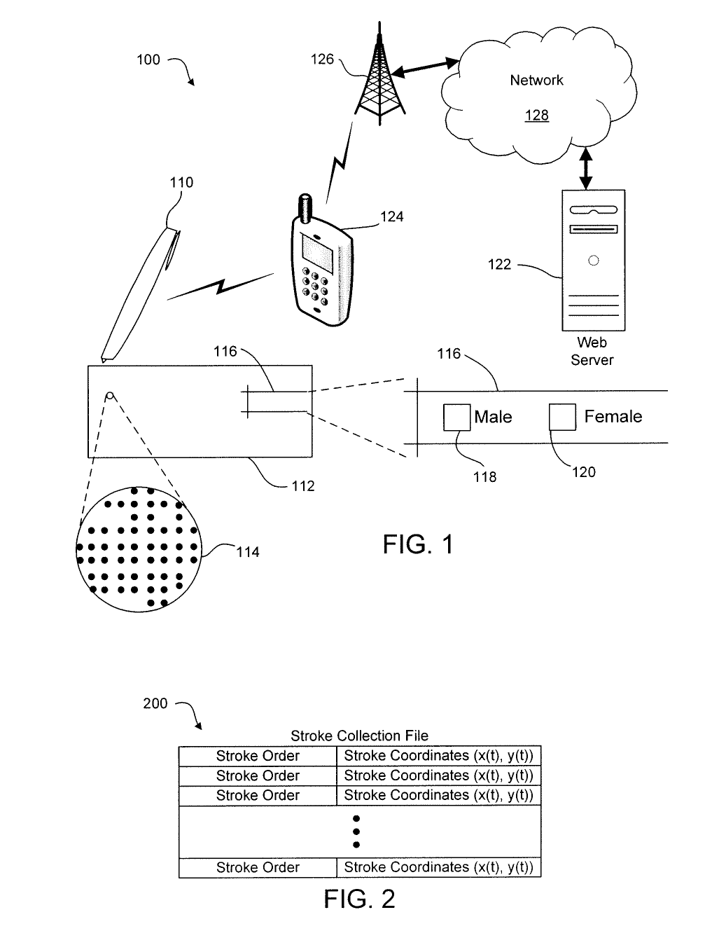

FIG. 1 is a block diagram of an example system 100 for processing data received from a digital pen 110 according to one embodiment. The digital pen 110 is configured to write on a paper form 112 and to electronically capture pen strokes in relation to a position-coding pattern 114 on a writing surface of the form 112. As discussed above, the digital pen 110 may include an Anoto-type pen. Thus, although not shown, the digital pen 110 may include a ball point tip, an ink cartridge, a camera with a lens that is directed toward the ball point tip, a pressure sensitive sensor that activates when pressure is applied to the ball point tip, a processor, a memory device, a communication device, and a power source. However, an artisan will recognize from the disclosure herein that other types of digital pens known in the art may also be used.

In one embodiment, a user may use the digital pen 110 to make pen strokes (e.g., in ink) on the form 112. The digital pen 110 determines the location of the pen strokes on the form 112 relative to the position-coding pattern 114 by analyzing the position-coding pattern 114 as pressure is applied to the ball point tip. Thus, each pen stroke is associated with a series of coordinates (x(t), y(t)) in, for example, a Cartesian coordinate system defined by the position-coding pattern 114. Here, x(t) corresponds to a unique location in the position-coding pattern 114 along an x-axis at a particular time during the stroke. Similarly, y(t) corresponds to a unique location in the position-coding pattern 114 along a y-axis at a particular time during the stroke.

In one embodiment, the form 112 includes one or more predetermined form fields 116 that a user may mark using the digital pen 110 to enter data or make a particular selection. The field 116 may be preprinted on the form 112 at a predetermined location with respect to the position-coding pattern 114. Thus, the position of a pen stroke relative to the position-coding pattern 114 may be used to determine if the user has marked a location within an area defined by the field 116.

In the example shown in FIG. 1, the field 116 is enlarged to illustrate that is a gender field with a first option 118 (Male) and a second option 120 (Female). An artisan will recognize from the disclosure herein, of course, that any type of field or option may be used and is not limited to a selection between male and female options.

Data for each stroke collected by the digital pen 110 may be stored in a stroke collection file that is communicated to a web server 122 through, for example, a user's cellular phone 124, a wireless communication system 126, and a network 128 such as the Internet or a local area network (LAN). In one embodiment, the digital pen 110 transmits data to the cellular phone 124 using Bluetooth®. In addition, or in another embodiment, the data may be retrieved from the digital pen 110 through a cable or docking station.

FIG. 2 is a block diagram of a data structure for an example stroke collection file 200 according to one embodiment. As a user makes a pen stroke on the form 112 using the digital pen 110, the digital pen 110 assigns a stroke order (e.g., first, second, third, etc.) to the stroke relative to previous pen strokes, if any, made on the particular form 112. After determining the coordinates (x(t), y(t)) of the stroke in relation to the position-coding pattern 114, the digital pen 110 adds the stroke's stroke order and stroke coordinates to the stroke collection file 200. When the user indicates that the form is complete (e.g., by marking a predetermined location on the form 112), the digital pen 110 transmits the stroke collection file 200 to the cellular phone 124 for further processing and transmission to the web server 122. In one embodiment, the web server 122 assigns a form “valid threshold” value to the stroke collection file 200 and stores the stroke collection file 200 in a database (not shown). The valid threshold value specifies a length of time (e.g., in number of minutes based on a 24 hour clock) that any single digital form is valid and/or available for updating. The valid threshold value may be completely configurable at the discretion of the user of the digital pen 110 and form 112 and/or a user (e.g., administrator) of the web server 122.

As discussed above, after the digital pen 110 transmits the original stroke collection file 200 corresponding to the original paper form 112 to the web server 122, the user may decide to update the original paper form 112 by making additional pen strokes on the form 112 using the digital pen 110. For example, the user may have transmitted the original stroke collection file 200 without having marked one of the options 118, 120 in the gender field 116. After realizing that the form 112 is not complete, the user may then select, for example, male by writing a check mark in the “Male” checkbox 118 using the digital pen 110. The digital pen 110 then determines the coordinates (x(t), y(t)) of the new stroke (check mark) in relation to the position-coding pattern 114 and adds the new stroke's stroke order and stroke coordinates to a new stroke collection file 200.

When the user has finished updating the original form 112, the digital pen 110 transmits the new stroke collection file 200 to the web server 122 for further processing. In one embodiment, processing form updates includes looping through the original stroke collection file 200 processing the series of X, Y strokes for all strokes collected in the new stroke collection file 200. In one embodiment, the web server 122 merges the stroke data from the original stroke collection file 200 and the new stroke collection file 200. In certain embodiments, the original and new stroke collection files 200 are only merged if the time defined by the valid threshold value corresponding to the original form 112 has not lapsed.

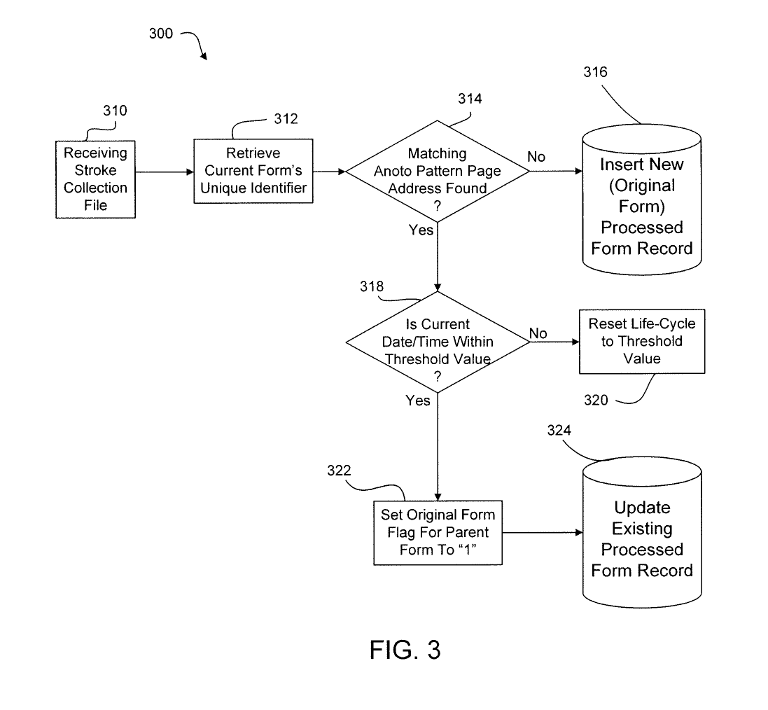

FIG. 3 is a flowchart of a method 300 for processing form updates according to one embodiment. The method 300 may be performed by, for example, the web server 122 shown in FIG. 1 to process stroke collection files corresponding to new forms and updates to existing forms. In one embodiment, the stroke collection files are proprietary formatted XML files that store pertinent data for the associated digital form record. This includes the form record's date/time stamp (e.g., date and time values recorded at the instant the stroke collection file was created such as “2006-04-19_{—}09-47-23-68”), user name of writer, hardware pen identifier, customer identifier, pattern page address, area dimensions, associated service and media data (e.g., photos an GPS coordinates), as well as X, Y coordinates of all strokes collected by a digital pen device on Anoto digital pattern paper.

The method 300 includes receiving 310 a stroke collection file and retrieving 312 a current form's unique identifier from the received stroke collection file. The unique identifier is associated with an Anoto pattern page from which the received stroke collection file was generated. The Anoto pattern page is a unique pattern of dots printed on standard paper which informs the digital pen device what page it is currently writing on as well as where the pen is located on that pattern page every, for example, 200 milliseconds, which is the basis for the X, Y coordinates stored in the stroke data file.

In one embodiment, the unique identifier comprises a unique name for the received digital stroke collection file. By way of example, and not by limitation, the unique identifier may be “21.6.15.16#0_ATA-AAA-P9M-F9_{—}2006-04-19_{—}09-47-23-68,” which signifies that the data in the stroke collection file is from Anoto pattern page 21.6.15.16 from pen ATA-AAA-P9M-F9 with the create date of 04-19-2006 and a create time of 09:47:23.68. Of course, an artisan will understand from the disclosure herein that any unique identifier may be used.

The method 300 then attempts to locate a form with the same Anoto pattern page as the current form being processed and queries 314 whether a match for the Anoto pattern page address is found. If a matching Anoto pattern page address is not found, then the current form is processed and inserted 316 (recorded) in a database as a new (e.g., original) processed form record. If, however, a matching Anoto pattern page address is found (e.g., another original form with the same Anoto pattern page exists in the database), then the method 300 checks the active threshold (e.g., the current number of minutes or hours that a particular form is valid) for that type of form and queries 318 whether a current date/time is within the threshold value.

Once the active threshold time (e.g., hours) have been exceeded, the method 300 resets 320 the life-cycle of the associated Anoto pattern page to the threshold value. A Life-Cycle reset is an indicator that signifies that a particular Anoto pattern page has exceeded its threshold value and therefore should be considered a new “Original Form.”

If, however, the difference between the current form's and the original form's date and time stamp is less than the form type's threshold value (e.g., in hours), then the method 300 sets 322 an original form flag for parent form to “1” (sets a validation status for the current form to be set to Update and sets the current form's OriginalForm flag to “1”), which indicates that it is the original form for that Anoto pattern page within the threshold's time (e.g., hour) value. The validation status is a proprietary integer status value stored in the processed form table for each processed stroke collection file, which indicates the form's status, including but not limited to: 0=Validated, 1=New Form, 2=Supervisor, 3=On-Hold and 4=Updated. The OriginalForm flag is a Boolean flag set in the processed form table indicating that a form record is the “master” record for subsequent updates to that original stroke collection.

The method 300 then updates 324 an existing processed form record by inserting an “update record” into a processed form table and storing the original form's stroke data (X, Y coordinates, pen force and acceleration values and Anoto pattern page specific information) retrieved from the stroke collection file in XML format in the database for tracking. A record is stored as an “update record” if an incoming stroke collection file's Anoto pattern page value matches an Anoto pattern page value already existing in the database, and the current date and time are within the valid threshold. In one embodiment, the processed form table is a proprietary formatted MS SQL table used to store form-level information for a newly processed stroke collection file.

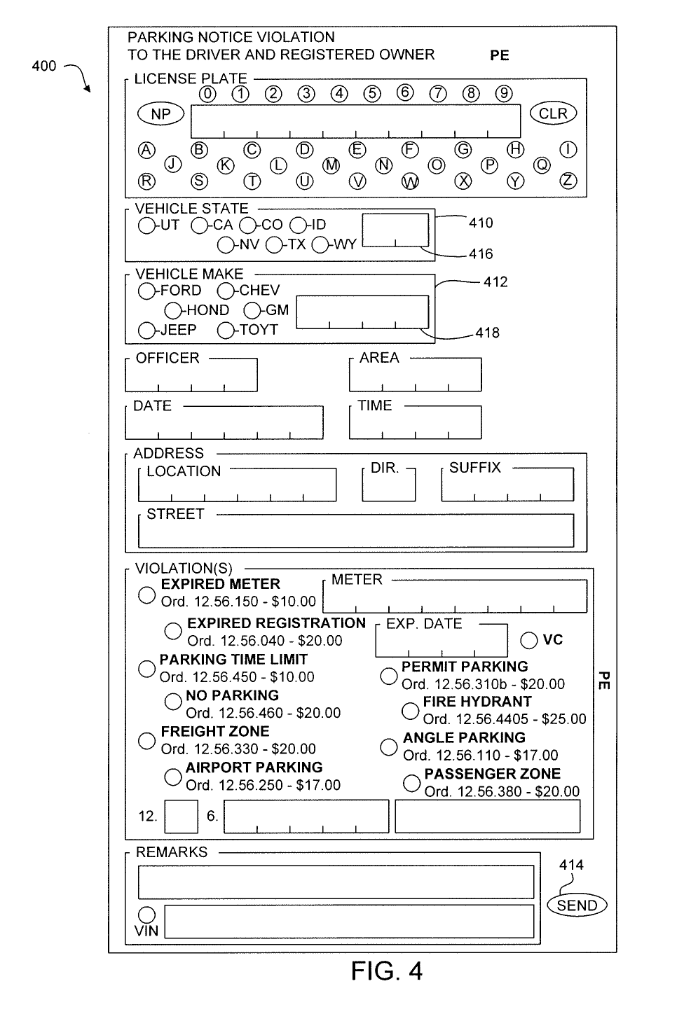

FIG. 4 graphically illustrates an example parking ticket 400 (Parking Notice Violation to the Driver and Registered Owner) with fields 410, 412 that respectively include options that may be processed according to certain embodiments disclosed herein. In one embodiment, the parking ticket 400 is a paper form including a position-coding pattern that is detectable by a digital pen, as discussed above. The parking ticket 400 may be filled out by a user such as a police officer or parking enforcement official using the digital pen.

When the user is finished writing information on the parking ticket 400, the user may write a pen stroke in or through a send field 414, which instructs the digital pen to send the data it has collected to the user's cellular phone or other communication device. The data collected by the digital pen may be sent to and automatically processed by a central web server that may enter field selections in a searchable database and/or render an electronic image of the parking ticket 400 with the desired pen strokes written by the user. The data may be used for violation enforcement and in automating the fine collection process.

As discussed in detail above, the user may decide to modify or update the parking ticket 400 after transmitting the data to the central web server. The parking ticket 400 may be updated by marking additional fields (e.g., fields 410, 412, 416, etc.) with the digital pen and writing another stroke through the send field 414. The user who wrote the ticket 400 may then leave the paper copy of the parking ticket 400 on a vehicle's windshield.

In the example embodiment shown in FIG. 4, a vehicle state field 410 allows the user to specify a state that issued a license plate for a vehicle in violation of a parking ordinance. Using a digital pen, the user may select one of a plurality of predefined states by writing a mark in a circle (or other symbol) next to the state's name or abbreviation. In this example, the predefined states include Utah (UT), California (CA), Colorado (CO), Idaho (ID), Nevada (NV), Texas (TX), or Wyoming (WY). If the license plates were issued by a state other than one of the predefined states, the user may also write the abbreviation of the appropriate state within a text box 416 in the vehicle state field 410.

By way of another example, a vehicle make field 412 shown in FIG. 4 allows the user to further identify the vehicle in violation of the parking ordinance by specifying the manufacturer of the vehicle. Using the digital pen, the user may select one of a plurality of predefined automobile manufacturers by writing a mark in a circle (or other symbol) next to the manufacturer's name or abbreviation. In this example, the predefined manufacturers include Ford (FORD), Chevrolet (CHEV), Honda (HOND), General Motors (GM), Jeep (JEEP), and Toyota (TOYT). If the vehicle was made by a manufacturer other than one of the predefined manufacturers, the user may also write the name or abbreviation of the appropriate manufacturer within a text box 418 in the vehicle make field 412.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

What is claimed is:

1. A method for updating data associated with a paper form received from a digital pen, the method comprising:
receiving a first stroke collection file comprising data corresponding to a plurality of pen strokes written on a paper form using a digital pen;
retrieving a unique identifier from the first stroke collection file corresponding to the paper form, the unique identifier associated with a dot pattern on the paper form;
determining a second stroke collection file stored in a database corresponding to the same dot pattern; and
if a threshold value based on an elapsed time since the second stroke collection file is not exceeded, updating data fields corresponding to the second stroke collection file with values from the first stroke collection file.
